(19) United States
(12) Patent Application Publication
(10) Pub. No.: US 2013/0082536 A1
(43) Pub. Date: Apr. 4, 2013

(54) SYSTEM AND METHOD FOR IMPROVED CONTROL IN WIRELESS POWER SUPPLY SYSTEMS

(71) Applicants: Joshua B. Taylor, Rockford, MI (US); Colin J. Moore, Grand Rapids, MI (US); David W. Baarman, Fennville, MI (US); Scott A. Mollema, Rockford, MI (US); Benjamin C. Moes, Wyoming, MI (US); Neil W. Kuyvenhoven, Ada, MI (US); Matthew J. Nibbelink, Grand Rapids, MI (US)

(72) Inventors: Joshua B. Taylor, Rockford, MI (US); Colin J. Moore, Grand Rapids, MI (US); David W. Baarman, Fennville, MI (US); Scott A. Mollema, Rockford, MI (US); Benjamin C. Moes, Wyoming, MI (US); Neil W. Kuyvenhoven, Ada, MI (US); Matthew J. Nibbelink, Grand Rapids, MI (US)

(73) Assignee: ACCESS BUSINESS GROUP INTERNATIONAL LLC, Ada, MI (US)

(21) Appl. No.: 13/425,841

(22) Filed: Mar. 21, 2012

Related U.S. Application Data
(60) Provisional application No. 61/466,133, filed on Mar. 22, 2011.

(51) Int. Cl. H02J 17/00; H01F 38/14

(52) U.S. Cl. CPC H02J 17/00; H01F 38/14
USPC 307/104

(57) ABSTRACT

A wireless power supply with an adaptive control system that is capable of adjusting various operating characteristics and that avoids operating at those operating characteristics that present adverse affects, such as impaired communications or interference with operation of the remote device. In one embodiment, the control system is capable of adjusting two or more of the operating frequency, duty cycle, rail voltage and switching circuit phase. In one embodiment, the wireless power supply control system is configured to detect operating characteristics that present adverse affects, maintain a record of those operating characteristics and avoid those operating characteristics once detected. In another embodiment, the remote device may be configured to advise the wireless power supply control system of certain “keep-out” ranges that adversely affect operation of the remote device.

### BACKGROUND OF THE INVENTION

The present invention relates to wireless power supply systems, and more particularly to systems and methods for improving control in a wireless power supply system.

Many conventional wireless power supply systems rely on inductive power transfer to convey electrical power without wires. A typical inductive power transfer system includes an inductive power supply that uses a primary coil to wirelessly transfer energy in the form of a varying electromagnetic field and a remote device that uses a secondary coil to convert the energy in the electromagnetic field into electrical power. Recognizing the potential benefits, some developers have focused on producing wireless power supply systems with adaptive control systems. Adaptive control systems may give the wireless power supply the ability to adapt operating parameters over time to maximize efficiency and/or control the amount of power being transferred to the remote device.

Conventional adaptive control systems may vary operating parameters, such as resonant frequency, operating frequency, rail voltage or duty cycle, to supply the appropriate amount of power and to adjust various operating conditions. For example, it may be desirable to vary the operating parameters of the wireless power supply based on the number of electronic device(s), the general power requirements of the electronic device(s) and the instantaneous power needs of the electronic device(s). As another example, the distance, location and orientation of the electronic device(s) with respect to the primary coil may affect the efficiency of the power transfer, and variations in operating parameters may be used to optimize operation. In a further example, the presence of parasitic metal in range of the wireless power supply may affect performance or present other undesirable issues. The adaptive control system may respond to the presence of parasitic metal by adjusting operating parameters or shutting down the power supply. In addition to these examples, those skilled in the field will recognize additional benefits from the use of an adaptive control system.

To provide improved efficiency and other benefits, it is not uncommon for conventional wireless power supply systems to incorporate a communication system that allows the remote device to communicate with the power supply. In some cases, the communication system allows one-way communication from the remote device to the power supply. In other cases, the system provides bi-directional communications that allow communication to flow in both directions. For example, the power supply and the remote device may perform a handshake or otherwise communicate to establish that the remote device is compatible with the wireless power supply. The remote device may also communicate its general power requirements prior to initiation of wireless power transfer and/or realtime information during wireless power transfer. The initial transfer of general power requirements may allow the wireless power supply to set its initial operating parameters. The transfer of information during wireless power transfer may allow the wireless power supply to adjust its operating parameters during operation. For example, the remote device may send communications during operation that include information representative of the amount of power the remote device is receiving from the wireless power supply. This information may allow the wireless power supply to adjust its operating parameters to supply the appropriate amount of power at optimum efficiency. These and other benefits may result from the existence of a communication channel from the remote device to the wireless power supply.

An efficient and effective method for providing communication in a wireless power supply that transfers power using an inductive field is to overlay the communications on the inductive field. This allows communication without the need to add a separate wireless communication link. One common method for embedding communications in the inductive field is referred to as “backscatter modulation.” Backscatter modulation relies on the principle that the impedance of the remote device is conveyed back to the power supply through reflected impedance. With backscatter modulation, the impedance of the remote device is selectively varied to create a data stream (e.g. a bit stream) that is conveyed to the power supply by reflected impedance. For example, the impedance may be modulated by selectively applying a load resistor to the secondary circuit. The power supply monitors a characteristic of the power in the tank circuit that is impacted by the reflected impedance. For example, the power supply may monitor the current in the tank circuit for fluctuations that represent a data stream.

Wireless power communications can be disrupted under certain circumstances. For example, a wireless power supply may not be able to detect communications if the wireless power supply is operating within certain operating parameters that cause interference with or otherwise mask communications. The inability of the system to detect communications can present a variety of issues. For example, the wireless power supply may be unable to make appropriate changes to its operating parameters if it is unable to receive communications from the remote device. Further, in some applications, the remote device is configured to send “keep-alive” signals to the wireless power supply. The keep-alive signal may, for example, tell the wireless power supply that a compatible remote device that needs power is present. If noise prevents a consecutive number of keep-alive signals from being recognized by the wireless power supply, the wireless power supply may stop transferring power to the remote device.

### SUMMARY OF THE INVENTION

The present invention provides an adaptive wireless power supply control system that is capable of adjusting various operating characteristics and that avoids operating at those operating characteristics that present adverse affects, such as impaired communications or interference with operation of the remote device. In one embodiment, the control system is capable of adjusting two or more of the operating frequency, duty cycle, rail voltage and switching circuit phase.

In one embodiment, the wireless power supply control system is configured to detect operating characteristics that present adverse affects, maintain a record of those operating characteristics and avoid those operating characteristics once detected. For example, with a control system that use operating frequency adjustment as its primary control, the control system may recognize that communications are impaired in certain operating frequency ranges. Once recognized, the control system may avoid operating in the problematic operating frequency ranges. Instead, a secondary control mechanism may be used when the control system would otherwise want to drive the operating frequency into a problematic frequency range. For example, if the control system was adjusting operating frequency to increase power supplied to the remote device and the operating frequency reached the boundary of a problematic frequency range, the control system might increase rail voltage or duty cycle instead of the continuing to adjust the operating frequency. In this way, the control system can continue to supply the power needs of the remote device while avoiding operating characteristics that might adversely affect operation of the wireless power supply or the remote device.

In another embodiment, the remote device may be configured to advise the wireless power supply control system of certain “keep-out” ranges that adversely affect operation of the remote device. The keep-out ranges may be predetermined, stored in the remote device and communicated to the wireless power supply control system prior to or during power supply. The remote device may provide specific information of the keep-out ranges or it may provide the wireless power supply control system with an identification that allows the control system to determine the keep-out ranges. For example, the remote device may provide an identification that is a key to a look-up table from which the control system can determine the applicable keep-out ranges. The identification may be tied to a device-type identification or it may be a separate identification.

In one embodiment, the wireless power supply control system may use a primary control to generally control the amount of power supplied to remote device and a secondary control that is used as an alternative to the primary control when appropriate to avoid operating characteristics with adverse affects. In some applications, the control system may use more than two alternative control methods. The specific primary and secondary controls may vary from application to application. The primary and secondary controls may vary depending on the type of power supply, for example, whether the system uses a half-bridge or full-bridge drive topology. Examples of some of the control methods that might be used with control system having a half-bridge drive topology include: (a) operating frequency as the primary control and rail voltage as the secondary control, (b) operating frequency as the primary control and duty cycle as the secondary control; (c) duty cycle as the primary control and rail voltage as the secondary control; and (d) rail voltage as the primary control and operating frequency as the secondary control. Examples of some additional control methods that might be used with control system having a full-bridge drive topology include: (a) operating frequency as the primary control and switching circuit phase as the secondary control, (b) rail voltage as the primary control and switching circuit phase as the secondary control; (c) switching circuit phase as the primary control and duty cycle as the secondary control; and (d) switching circuit phase as the primary control and operating frequency as the secondary control.

The present invention provides a simple and effective control system that allows an adaptive wireless power supply to adjust its characteristics to supply the power needs of the remote device while avoiding operating characteristics that might adversely affect operation of the wireless power supply or the remote device. The present invention can reduce the risk of problems with communications caused by operation in specific frequency ranges. The present invention can also reduce the risk of the wireless power supply interfering with proper operation of the remote device. For example, the control system can avoid operating characteristics that cause internal interference within the remote device, such as operation at a frequency too close to a clock signal on the remote device or operation at a duty cycle that creates undesirable harmonics. This control system can also employ a secondary control when the limits of the primary control have been reached. For example, a control system that uses rail voltage as its primary control and operating frequency as its secondary control, may switch to operating frequency control when a maximum or minimum rail voltage has been reached and further adjustments in power are desired.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is schematic representation of a wireless power supply and remote device in accordance with an embodiment of the present invention.

FIG. 2 is a schematic representation of an alternative embodiment of the wireless power supply and remote device.

FIG. 3 is schematic representation of a portion of the wireless power supply of FIG. 1.

FIG. 4 is a timing diagram showing the timing of the switches of FIG. 3 operating with 180 degrees offset.

FIG. 5 is a timing diagram showing the timing of the switches of FIG. 3 operating with 135 degree offset.

FIG. 6 is a timing diagram showing the timing of the switches of FIG. 3 when operating at a reduced duty cycle.

FIG. 7 is a flowchart showing the general step of a method in accordance with an embodiment of the present invention.

FIG. 8 is a flowchart showing the general step of a method in accordance with an alternative embodiment.

FIG. 9 is a representative graph that includes a null point at which communications may be undetectable in the wireless power supply.

FIG. 10 is a table showing various system values during a period of operation in which the power transmitted to the remote device is decreased.

### DESCRIPTION OF THE CURRENT EMBODIMENT

A. Overview.

The present invention relates to wireless power supplies with adaptive control and methods for providing adaptive control of a wireless power supply. The systems and methods of the present invention generally relate to control of the wireless power supply in a way that addresses or avoids the potential issues, such as loss of communications, impairment of function or other problems, caused by operating a wireless power supply within certain adverse operating ranges. The present invention is well-suited for addressing the potential loss of communications that may occur when the wireless power supply is operating within parameters that create interference with, mask or otherwise hinder communications from the remote device. For example, the present invention may help address the loss of communications in a wireless power supply that receives communications from the remote device through backscatter modulation in which communications are reflected back to the wireless power supply via the inductive power link (or electromagnetic field) established between the wireless power supply and the remote device. The present invention is well-suited for use in protecting communications of various types. For example, the present invention may preserve the ability of the wireless power supply to receive control signals relating to operation of the wireless power transfer system, such as signals that identify the remote device, provide wireless power supply control parameters or provide information in real-time relating to wireless power supply (e.g. current, voltage, temperature, battery condition, charging status and remote device status). As another example, the present invention may preserve the ability of the wireless power supply to receive communications relating to the transfer of data unrelated to the wireless power transfer system, such as transferring information associated with features of the remote device, including synchronizing calendars and to-do lists or transferring files (e.g. audio, video, image, spreadsheet, database, word processing and application files—just to name a few). The present invention is described in the context of various embodiments in which communication are transmitted from a remote device to the wireless power supply. Although not described in detail, it should be understood that the present invention may also be used to preserve communications from the wireless power supply to the remote device.

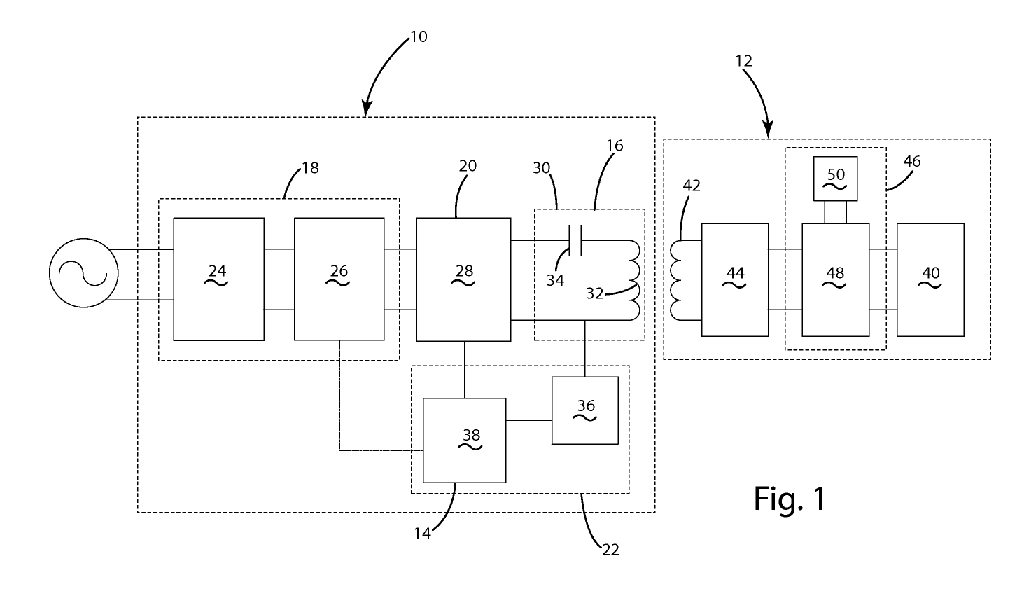

A wireless power supply 10 and remote device 12 in accordance with an embodiment of the present invention are shown in FIG. 1. The wireless power supply 10 generally includes an adaptive control system 14 and a wireless power transmitter 16. The control system 14 is configured to adjust operating characteristics to, among other things, improve transfer efficiency and control the amount of power supplied to the remote device 12. The adaptive control system 14 is adaptable using at least two different control methods, such as adjustment of the operating frequency of the signal applied to the wireless power transmitter 16, rail voltage used to produce the signal applied to the wireless power transmitter 16, duty cycle of the signal applied to the wireless power transmitter 16 or phase of signal applied to the wireless power transmitter 16. The control system 14 is configured to alternate between the two different control methods to avoid operating characteristics that might adversely affect one or more components in the system, such as impairing communications or interfering with operation of the remote device. During operation, the adaptive control system 14 may use a primary control, such as adjustment of operating frequency, as the principle mechanism for controlling the efficiency of the system or the amount of power transferred to the remote device, and may use a secondary control, such as adjustment of the duty cycle, when further adjustments using the primary control would cause the control system to operate with characteristics that might adversely affect the system.

The adaptive control system 14 may be configured to adjust operation based on determinations made on the primary side or it may be configured to adjust operation based on control signals (e.g. communications) received from the remote device 12. As one example, the adaptive control system 14 may monitor one or more characteristics of power in the wireless power supply (e.g. current in the tank circuit) and make adjustments to its operating parameters. As another example, the remote device 12 may be configured to send communication signals directing the control system 14 to increase power, decrease power, remain constant or shut off. The control system 14 may typically increase power by making appropriate adjustments to the primary control, and may switch to adjustments to the secondary control when further adjustment of the primary control would cause the system to operate at characteristics that might adversely affect operation of the system or when further adjustment of the primary control in the desired direction is no longer possible, for example, because a limit has been reached.

The control system 14 may determine undesirable operating characteristics (or ranges of characteristics) during operation, may be provided with undesirable operating characteristics in advance (for example, in a table stored in memory), and/or may be advised of undesirable operating characteristics by the remote device (for example, at the initiation of a power supply session or during operation). In an alternative embodiment, the control system 14 may not be advised of undesirable operating parameters, but may instead receive control signals from the remote device that cause the control system to avoid undesirable operating parameters. The remote device 12 may determine the undesirable operating parameters during operation and/or may be provided with undesirable operating characteristics in advance.

B. System.

An embodiment of the present invention will now be described with reference to FIG. 1. The wireless power supply 10 of the FIG. 1 embodiment generally includes a power supply 18, signal generating circuitry 20, a wireless power transmitter 16, a communication receiver 22 and an adaptive control system 14. The power supply 18 may be a conventional power supply that transforms an AC input (e.g. wall power) into an appropriate DC output that is suitable for driving the wireless power transmitter 16. As an alternative, the power supply 18 may be a source of DC power that is appropriate for supplying power to the wireless power transmitter 16. In this embodiment, the power supply 18 generally includes a rectifier 24 and a DC-DC converter 26. The rectifier 24 and DC-DC converter 26 provide the appropriate DC power for the power supply signal. The power supply 18 may alternatively include essentially any circuitry capable of transforming input power to the form used by the signal generating circuitry 20. In this embodiment, the adaptive control system 14 is configured to adjust operating parameters by changing operating frequency and duty cycle. Accordingly, the DC-DC converter 26 may have a fixed output. The adaptive control system 14 may additionally or alternatively have the ability to adjust rail voltage or switching circuit phase (described in more detail below). In an alternative embodiment where it is desirable to adjust operating parameters by varying the rail voltage, the DC-DC converter 26 may have a variable output. As shown in FIG. 1, the adaptive control system 14 may be coupled to the DC-DC converter 26 (represented by broken line) to allow the adaptive control system 14 to control the output of the DC-DC converter 26.

In this embodiment, the signal generating circuitry 20 includes switching circuitry 28 that is configured to generate and apply an input signal to the wireless power transmitter 16. The switching circuitry 28 may vary from application to application. For example, the switching circuitry may include a plurality of switches, such as MOSFETs, arranged in a half-bridge topology or in a full-bridge topology. In this embodiment, the power transmitter 16 includes a tank circuit 30 having a primary coil 32 and a ballast capacitor 34 that are arranged to form a series resonant tank circuit. The present invention is not, however, limited to use with series resonant tank circuits and may instead be used with other types of resonant tank circuits and even with non-resonant tank circuits, such as a simple inductor without matching capacitance. Although the illustrated embodiment includes a primary coil, the wireless power supply 10 may include alternative inductors capable of generating a suitable electromagnetic field.

In this embodiment, the communication receiver 22 includes a detector circuit 36 and portions of controller 38. The communications receiver 22 and related communications method described herein are exemplary. The present invention may be implemented using essentially any systems and methods capable of receiving communication over the inductive power link. Suitable communications receivers (including various alternative detector circuits) and various alternative communications methods are described in U.S. application Ser. No. 13/012,000, which is entitled SYSTEMS AND METHODS FOR DETECTING DATA COMMUNICATION OVER A WIRELESS POWER LINK, and was filed on Jan. 24, 2011, by Matthew J. Norconk et al, and U.S. Provisional Application No. 61/440,138, which is entitled SYSTEM AND METHOD OF PROVIDING COMMUNICATIONS IN A WIRELESS POWER TRANSFER SYSTEM, and was filed on Feb. 7, 2011, by Matthew J. Norconk et al, both of which are incorporated herein by reference in their entirety.

The detector circuit 36 is coupled to the tank circuit 30 to allow the detector circuit 36 to provide a signal indicative of one or more characteristics of the power in the tank circuit 30, such as the current, voltage and/or any other characteristic that is affect by reflected impedance from the remote device 12. In one embodiment, the detector circuit 36 includes a current sense transformer (not shown) that is coupled to the tank circuit 30 to provide a signal corresponding to the magnitude of the current in the tank circuit. Although not shown, the detector circuit 36 may include circuitry to filter, process and convert the signal produced by the sensor into a series of high and low signals representative of the data carried over the inductive power link.

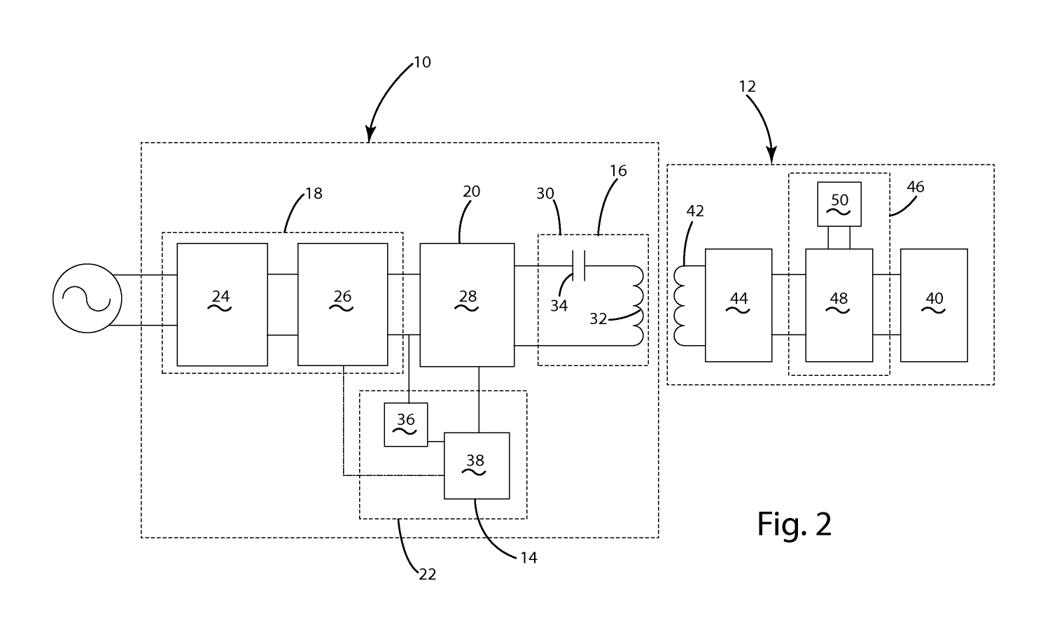

The detector circuit 36 is coupled to the tank circuit 30 in this embodiment, but may be coupled elsewhere as described in more detail below. For example, as shown in FIG. 2, the detector circuit 36′ may be coupled to the input to the switching circuitry 28. In this alternative embodiment, the detector circuit 36′ may be configured to receive communication by processing a signal indicative of the input power supplied to the switching circuit 36′. Suitable systems and methods for obtaining communications from the input power are described in U.S. application Ser. No. 13/012,000, which as noted above is incorporated herein by reference in its entirety.

The detector circuit described generally above may be implemented in a wide variety of different embodiments. For example, the detector circuit may vary from embodiment to embodiment depending upon the type of modulation/demodulation implemented in that embodiment and/or depending on the details of the power supply circuitry. Further, each modulation/demodulation scheme may be implemented using a variety of different circuits. Generally speaking, the detector circuit is configured to produce an output signal as a function of a characteristic of power in the power supply that is affected by data communicated through reflected impedance.

The output of the detector circuit 36 is coupled to the controller 38 so that communications contained in the output can be extracted and demodulated into communications. In the illustrated embodiment, the detector circuit 36 is configured to filter and process the sensed signal to provide an output signal that is a series of high and low signals corresponding to the communications overlaid onto the inductive power link. In applications of this type, the controller 38 may process the high and low signals to convert the high and low signals into binary data using conventional techniques and apparatus. In the illustrated embodiments, the remote device 12 uses a bi-phase encoding scheme to encode data. With this method, a binary 1 is represented in the encoded data using two transitions with the first transition coinciding with the rising edge of the clock signal and the second transition coinciding with the falling edge of the clock signal. A binary 0 is represented by a single transition coinciding with the rising edge of the clock signal. Accordingly, the controller 38 is configured to decode the detector circuit output using a corresponding scheme.

The adaptive control system 14 includes portions of controller 38 and is configured, among other things, to operate the switching circuitry 28 to produce the desired power supply signal to the power transmitter 16. The adaptive control system 14 may control the switching circuitry 28 based on communications received from the remote device 12 via the communication receiver 22. As can be seen, the wireless power supply 10 of this embodiment includes a controller 38 that performs various functions, such as controlling the timing of the switching circuit 28 and cooperating with the detector circuit 36 to extract and interpret communications signals. These functions may alternatively be handled by separate controllers or other dedicated circuitry.

In an alternative embodiment, the wireless power supply 10 may be configured to use operating frequency as the primary control and rail voltage as the secondary control. In this embodiment, the wireless power supply 10 may include a DC-DC converter that provides variable output. The adaptive control system 14 may be configured to send control signals to the DC-DC converter to control the output of the variable DC-DC converter.

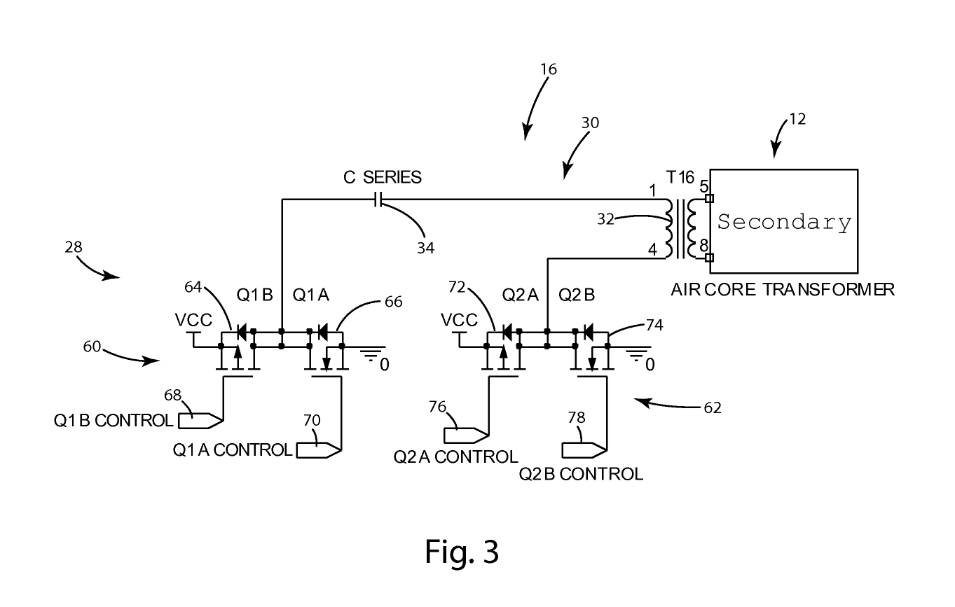

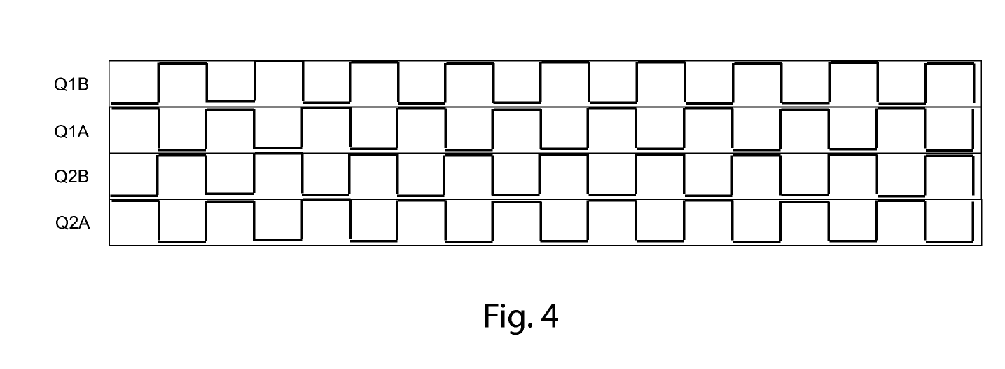

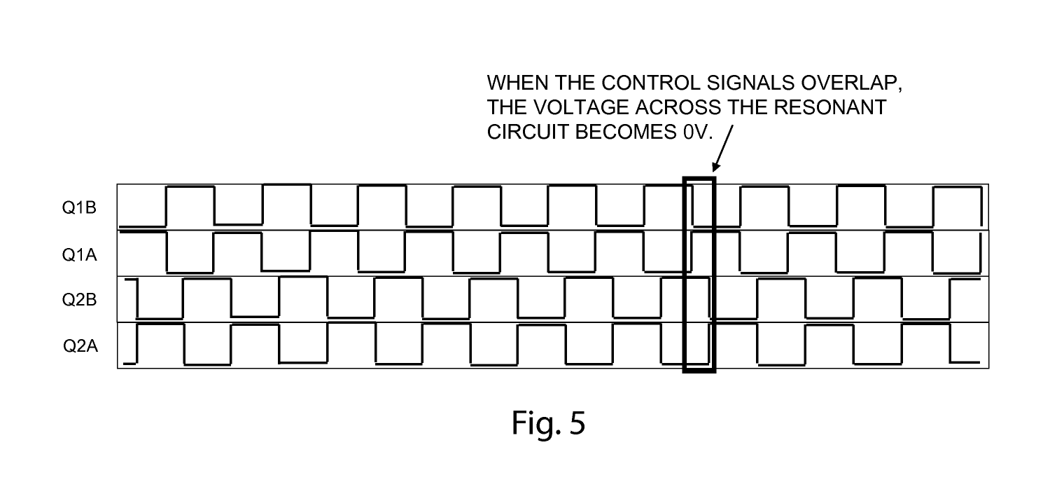

In another alternative embodiment, the wireless power supply 10 may be configured to use operating frequency as the primary control and phase of the switching circuit as the secondary control. In this embodiment, term “switching circuit phase” refers to the timing of the switches in the switching circuit—and not to a direct adjustment in the phase relationship between the voltage and current in the tank circuit. More specifically, in this embodiment, a switching circuit phase adjustment is achieved by providing an offset between the timing of the switches without changing the frequency at which the switches are operated. In the embodiment of FIG. 3, phase control is achieved using a full bridge switching circuit topology. FIG. 3 is a simplified circuit diagram that shows two pairs of switches 60 and 62 (each pair making up a half-bridge circuit) coupled to the tank circuit 30, as well as a simplified representation of a remote device positioned near the primary coil 32. In this embodiment, the first pair of switches 60 includes high-side switch 64 and low-side switch 66. These switches 64 and 66 receive control signals from the adaptive control system 14 via Q1B control line 68 and Q1A control line 70, respectively. Similarly, the second pair of switches 62 includes high-side switch 72 and low-side switch 74, which receive control signals from the adaptive control system 14 via Q2A control line 76 and Q2B control line 78. FIG. 4 represents the timing of the various switches when they are operated in a normal manner with a 180-degree offset between the two half bridge circuits. By adjusting the phase (or offset) of the two half bridge circuits, the current can be adjusted. FIG. 5 represents the timing of the various switches when they are operated at a 135-degree offset. When the control signals overlap (see, for example, region A of FIG. 5), the voltage across the tank circuit 30 becomes 0V. This reduces the amount of current as compared with the 180 degree timing shown in FIG. 4. The specific offset between the two half-bridge circuits can be varied to adjust the amount of power transmitted to the remote device 12.

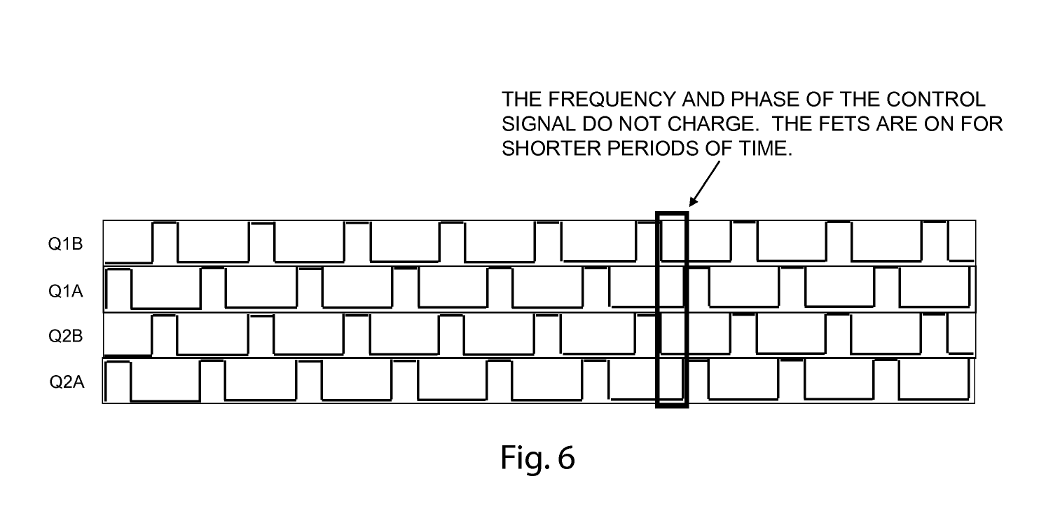

In another alternative embodiment, the adaptive control system 14 may use duty cycle control as either the primary control or the secondary control. For purposes of disclosure, the general operation of duty cycle control will be described in connection with FIG. 6. To implement duty cycle control in this embodiment, the adaptive control system 14 may open all of the switches for a specific period of time during each cycle. While the switches are open, the switching circuit will not apply a voltage to the tank circuit 30 and therefore will reduce the power supplied to the tank circuit 30 and consequently the remote device 12. The amount of time that the switches are off may be varied to change the desired duty cycle and deliver the desired power.

A remote device 12 in accordance with an embodiment of the present invention will now be described in more detail with respect to FIG. 1. The remote device 12 may include a generally conventional electronic device, such as a cell phone, a media player, a handheld radio, a camera, a flashlight or essentially any other portable electronic device. The remote device 12 may include an electrical energy storage device, such as a battery, capacitor or a super capacitor, or it may operate without an electrical energy storage device. The components associated with the principle operation of the remote device 12 (and not associated with wireless power transfer) are generally conventional and therefore will not be described in detail. Instead, the components associated with the principle operation of the remote device 12 are generally referred to as principle load 40. For example, in the context of a cell phone, no effort is made to describe the electronic components associated with the cell phone itself.

The remote device 12 of this embodiment generally includes a secondary coil 42, a rectifier 44, a communications transmitter 46 and a principle load 40. The secondary coil 42 may be a coil of wire or essentially any other inductor capable of generating electrical power in response to the varying electromagnetic field generated by the wireless power supply 10. The rectifier 44 converts the AC power into DC power. Although not shown, the device 12 may also include a DC-DC converter in those embodiments where conversion is desired. In applications where AC power is desired in the remote device, the rectifier 44 may not be necessary. The communications transmitter 46 of this embodiment includes a controller 48 and a communication load 50. In addition to its role in communications, the controller 48 may be configured to perform a variety of functions, such as applying the rectified power to the principle load 40. In some applications, the principle load 40 may include a power management block capable of managing the supply of power to the electronics of the remote device 12. For example, a conventional electronic device may include an internal battery or other electrical energy storage device (such as a capacitor or super capacitor). The power management block may determine when to use the rectified power to charge the device's internal battery and when to use the power to power the device. It may also be capable of apportioning the power between battery charging and directly powering the device. In some applications, the principle load 40 may not include a power management block. In such applications, the controller 48 may be programmed to handle the power management functions or the electronic device 14 may include a separate controller for handling power management functions.

With regard to its communication function, the controller 48 includes programming that enables the controller 48 to selectively apply the communication load 50 to create data communications on the power signal using a backscatter modulation scheme. In operation, the controller 48 may be configured to selectively couple the communication load 50 to the secondary coil 42 at the appropriate timing to create the desired data transmissions. The communication load 50 may be a resistor or other circuit component capable of selectively varying the overall impedance of the remote device 12. For example, as an alternative to a resistor, the communication load 50 may be a capacitor or an inductor (not shown). Although the illustrated embodiments show a single communication load 50, multiple communication loads may be used. For example, the system may incorporate a dynamic-load communication system in accordance with an embodiment of U.S. application Ser. No. 12/652,061 entitled COMMUNICATION ACROSS AN INDUCTIVE LINK WITH A DYNAMIC LOAD, which was filed on Jan. 5, 2010, and which is incorporated herein by reference in its entirety. Although the communications load 50 may be a dedicated circuit component (e.g. a dedicated resistor, inductor or capacitor), the communication load 50 need not be a dedicated component. For example, in some applications, communications may be created by toggling the principle load 40 or some portion of the principle load 40.

Although shown coupled to the controller 48 in the schematic representations of FIGS. 1 and 2, the communications load 50 may be located in essentially any position in which it is capable of producing the desired variation in the impedance of the remote device 12, such as between the secondary coil 42 and the rectifier 44.

As noted above, the wireless power supply 10 and remote device 12 of the illustrated embodiment are configured to communicate over the inductive power link. Although the communications may be two-way, in the illustrated embodiment, the communications go only one way from the remote device 12 to the wireless power supply 10. In this embodiment, the remote device 12 communicates by increasing or decreasing its load to create digital communications on top of the power supply signal. In the illustrated embodiment, the remote device 12 varies its load by modulating a resistor into the circuit. Although the illustrated embodiment uses a communication resistor to create communications, the remote device 12 may alternatively create load in other ways, for example, by applying a communications capacitor or some other internal circuit component capable of varying the load with sufficient magnitude to create communication signals that will reflect back to the wireless power supply 10 through reflected impedance. The wireless power supply 10 and remote device 12 may be configured to communicate using essentially any data encoding scheme, but in the illustrated embodiment may use biphase encoding in which the number of transitions during a clock cycle between the two logical states

C. Methods of Operation.

The methods of the present invention are described primarily in the context of embodiments in which the adaptive control system 14 is implementing the present invention to avoid operating parameters that adversely affect communications from the remote device 12 to the wireless power supply 10. The present invention may additionally or alternatively be implemented to address other adverse operating conditions. Generally speaking, the adaptive control system 14 may be configured to avoid essentially any operation parameters that have an adverse impact on operation of the remote device 12 and/or wireless power supply 10. For example, in some applications, operation of the wireless power supply 10 within certain operating parameters may interfere with internal operation of the remote device 12, such as creating noise that interferes with a cell phone's ability to receive cellular data or producing harmonics that might impact operation of a remote device touch screen.

In the illustrated embodiment, the remote device 12 is configured to use communications to identify the device 12 and to control the amount of power received from the wireless power supply 10. For example, the wireless power supply 10 and the remote device 12 may initiate power supply by establishing the identity and/or type of remote device 12, which may be done in part to confirm compatibility with the wireless power supply 10 before transmitting power. The remote device 12 may send one or more communications packets that contain the information desired for establishing an inductive power link between the wireless power supply 10 and the remote device 12. The wireless power supply 10 may also use the identity and/or type of the remote device 12 to establish initial operating parameters for the wireless power supply 10, such as initial operating frequency, duty cycle and rail voltage parameters. In systems that have the ability to adjust the resonant frequency of the wireless power supply, the initial operating parameters may also include an initial resonant frequency parameter. The remote device 12 may communicate the initial operating parameters to the wireless power supply 10 in some embodiments.

During operation, the remote device 12 may send communications that dictate operation of the wireless power supply 10, for example, by providing communications that drive adjustments in the operating parameters of the wireless power supply 10. In the illustrated embodiment, the remote device 12 is configured to send communications that tell the wireless power supply 10 whether to increase power, decrease power or take other action. More specifically, the remote device 12 of the illustrated embodiment is programmed to periodically send a communication packet that gives the wireless power supply 10 the ability to properly adjust its operating parameters. For example, the remote device 12 of the illustrated embodiment may send a communication packet every 250 ms that includes data representative of the amount of power being received by the remote device 12. The data may be representative of the distance that the current power is away from the desired power, such as a percentage above or below the power desired by the remote device 12. This may allow the adaptive control system 14 to adjust the size of the adjustment made to the operating parameter. For example, the size of the adjustment may be proportional to the distance away from the desired power level.

The wireless power supply 10 may also use the communication packet as a “keep alive” signal. If the wireless power supply 10 does not receive a communication packet for a certain period of time, the wireless power supply 10 may take remedial action, such as adjusting operating parameters in an effort to re-establish communications or terminating the inductive power link. A loss of communication may mean that the wireless power supply 10 has entered adverse operating conditions that are preventing communications from being received or it may mean that the remote device 12 has been removed or has entered a state during which no power is desired (e.g. when the remote device 12 batteries are fully charged). In this embodiment, the wireless power supply 10 is configured to turn off the inductive power link if a communication packet has not been received within a time period, such as 1.25 seconds. The length of this time period may vary from application to application as desired, but it will typically be of sufficient length to allow the adaptive control system 14 to make one or more adjustments that may move the system 14 out of an adverse operating range in case that happens to be the reason for the loss of communications.

As discussed above, the adaptive control system 14 has the ability to adjust the operating parameters of the wireless power supply 10. Although the adaptive control system 14 may have the ability to adjust essentially any parameters that might affect power transfer efficiency or power transfer level, the adaptive control system 14 of the illustrated embodiment has the ability to adjust operating frequency and duty cycle. In this embodiment, the control system 14 uses operating frequency adjustment as its primary control and duty cycle adjustment as its secondary control. As discussed above, the control parameters may vary from application to application. A table listing some control methods that be used with a wireless power supply having a half-bridge switching circuit topology is as follows:

| Primary | Secondary | |
|---|---|---|
| Control | Control | Potential reasons to change |
| Frequency | Rail | Frequency keep out area for the transmitter |
| | | due to interference |
| Frequency | Duty Cycle | Frequency keep out area for the secondary |
| | | device internal interference |
| Duty Cycle | Rail | Harmonic content from duty cycle operation |
| Rail | Frequency | A minimum/maximum rail voltage was |
| | | reached and further adjustments were |
| | | required |

A table listing some additional control methods that might be used with a wireless power supply having a full-bridge switching circuit topology is a as follows:

| Primary | Secondary | |
|---|---|---|
| Control | Control | Potential reasons to change |
| Frequency | Phase | Frequency keep out area for the transmitter due |
| | | to interference |
| Rail | Phase | A minimum/maximum rail voltage was |
| | | reached and further adjustments were required |
| Phase | Duty Cycle | A minimum/maximum phase was reached and |
| | | the transmitter has no option of frequency or |
| | | rail adjustment |
| Phase | Frequency | A phase angle with know secondary issues may |
| | | be communicated to the transmitter |

In this embodiment, the control system 14 includes a sensor for monitoring a characteristic of power in the wireless power supply 10 that is affected by reflected impedance from the remote device 12. For example, the adaptive control system 14 may monitor current in the tank circuit to extract communications sent from the remote device 12 using backscatter modulation (or any other method for adding communications onto the inductive power link). Some other methods for extracting communications modulated onto the inductive power link may include monitoring primary coil voltage, monitoring the phase of the power within the tank circuit or monitoring the current of the input power supplied to the tank circuit.

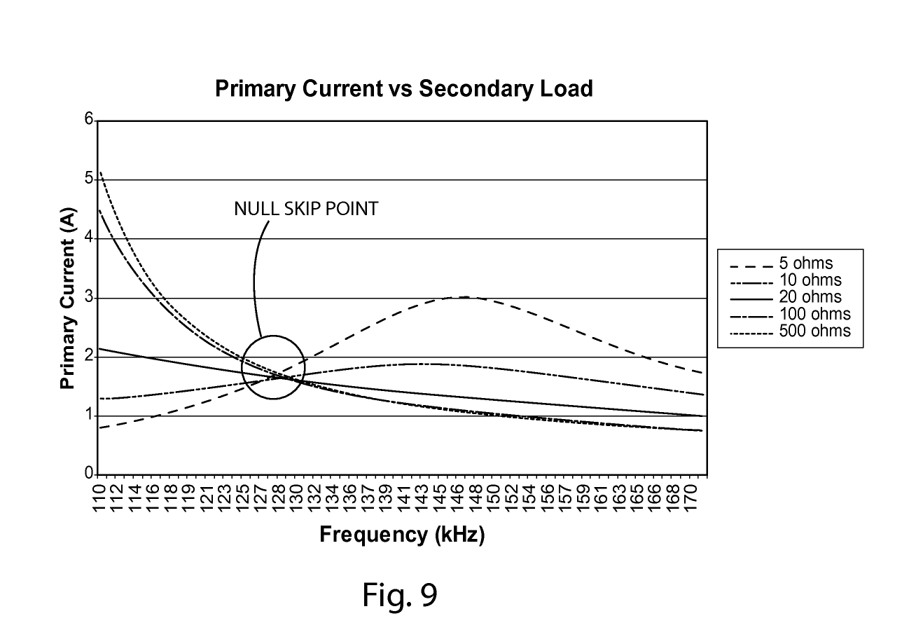

As discussed above, operation of a wireless power supply under certain operating parameters can mask communications or have other negative impacts on the operation of the system. For example, in some applications, a wireless power supply 10 may be unable to detect communications from the remote device 12 when the reflected impedance does not change despite application of the communication load or the modulation reflected back to the wireless power supply 10 is below a minimum detectable threshold in the wireless power supply 10. A representative sample of this is shown in FIG. 9. FIG. 9 is a graph of primary current (e.g. current in the tank circuit) against secondary load (e.g. total load of the remote device). As can be seen, there is a region around 128 kHz where changes in the secondary load, such as applying the communication load, do not result in changes to the primary current. This region may be referred to as a “null point” or a “keep out” range. If communications are sent by the remote device 12 while the adaptive control system 14 is operating at or around 128 kHz, the communication receiver will be unable to detect communications by sensing primary current.

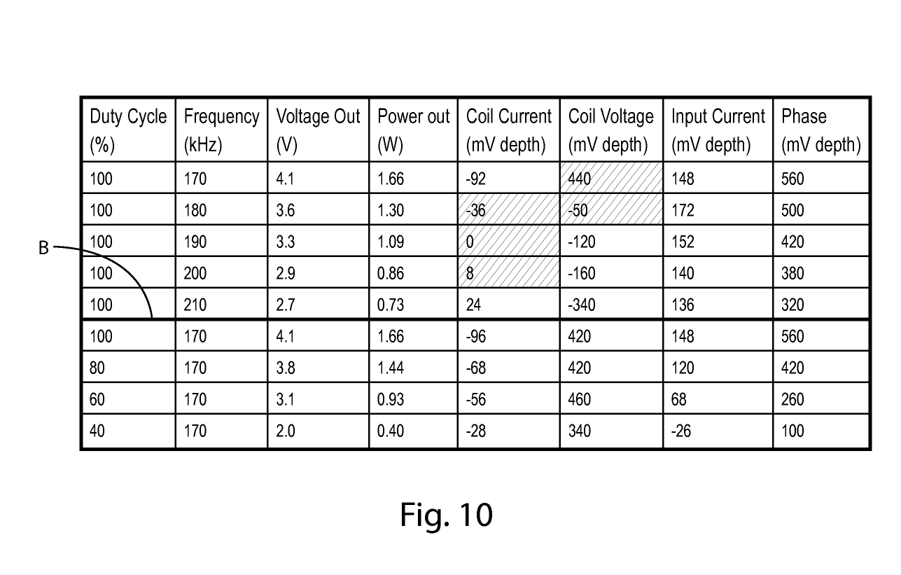

FIG. 10 is a table illustrating the potential benefit of switching between control methods. The table shows a variety of system values during a period of operation where the remote device 12 is repeatedly requesting less power and the system 14 is adjusting operating parameters accordingly. In this illustration, the adaptive control system 14 is capable of using either operating frequency or duty cycle to reduce the power supplied to the remote device 12. The duty cycle and operating frequency values are provided in the first two columns of the table. The “Voltage Out” and “Power Out” columns refer to the rectifier voltage and the power in the remote device 12. The last four columns show the filtered modulation depth of communications using various detection methods. Communication depth is a measure of the distinctiveness of the communication modulations in the wireless power supply 10, or the measured change in the observed operating conditions of the wireless power supply with time. The lower the communication depth, the less distinctive the communication modulations. It may not be possible for the wireless power supply 10 to detect communications when the communication depth is at or near zero, or inverts. The “Coil Current” column shows communication depth when communications are detected by sensing current in the tank circuit 30. The “Coil Voltage” column shows the communication depth when communications are detected by sensing current in the tank circuit 30. The “Input Current” column shows the communication depth when communications are detected by sensing current in input signal to the switching circuit 36. Finally, the “Phase” column shows communication depth when communications are detected by sensing phase between the voltage and the current in the tank circuit 30. The table is divided into two parts by a bold line B. The upper portion of the table shows the various system values when the operating frequency is adjusted and duty cycle remains constant at 100 percent. The lower portion of the table shows the various system values when the duty cycle is adjusted and the operating frequency is held constant at 170 kHz. As can be seen, the upper portion of the chart shows one spot (at 190 kHz) where the communication depth for Coil Current is zero. At this operating frequency, the system 14 would be unable to detect communications. Similarly, at some frequency between 170 kHz and 180 kHz, the communication depth for Coil Voltage will be zero. Again, at that frequency, the system will be unable to detect communications. On the other hand, the lower portion of the table shows that if the operating frequency is retained at 170 kHz, the duty cycle can be adjusted from 1.44 watts to 0.4 watts without causing communication depth in either Coil Current or Coil Voltage to be zero. Accordingly, duty cycle control can be used during this particular period of control without losing communications even though operating frequency control would result in a loss of communication (at least with respect to communications detected through Coil Current or Coil Voltage).

To address those situations where communications are masked because of the operating parameters, the adaptive control system 14 is configured to take remedial action if communications are lost. For example, in some situations, operating at or within certain frequency ranges can cause interference with or otherwise mask communications from the remote device 12 to the wireless power supply 10. In an effort to overcome these types of issues, the adaptive control system 14 of the illustrated embodiment is configured to continue to adjust operating parameters for a period of time after the wireless power supply 10 stops receiving communications. The adaptive control system 14 may be configured to continue to adjust the operating parameter in the same direction as its last adjustment when communications are lost. If the loss of communication is the result of the operating parameters reaching adverse operating parameters continuing to adjust the operating parameters may move the system out of the adverse parameters and allow communications to be re-established. In the illustrated embodiment, the adaptive control system 14 is configured to continue to make step-by-step adjustments to the control parameter in an effort to move out of the operating parameters that created the loss of communication. The adaptive control system 14 may stop the inductive power link if communications are not re-established within a specific period of time or after a specified number of adjustments.

In operation, the adaptive control system 14 may be configured to continue to make adjustments in the same direction as the last step that occurred while communications were still being received. For example, if the adaptive control system 14 last adjusted the system by increasing operating frequency, the system 14 may respond to a loss of communication by continuing to increase the operating frequency in an effort to move through the interference range and re-establish communications. Alternatively, the adaptive control system 14 may reverse the adjustment to the primary control that created the adverse affect and may attempt to reach the desired power level using the secondary control.

Once communications are re-established, it is possible that the adjustments made to re-establish communications will have adjusted power too far (either up or down). For example, once communications are re-established the remote device 12 may request to have power adjusted back in the opposite direction. In such cases, it will be evident that normal adjustment of the primary control would cause the remote device 12 to operate within operating parameters that adversely affect the system in order to receive power at the appropriate level. In response, the adaptive control system 14 may adjust a secondary control (rather than the primary control) in an effort to provide the proper amount of power without moving the primary control into an operating range that has adverse affects. For example, if the operating frequency was the primary control, the adaptive control system 14 may leave the operating frequency at a frequency that allows communication and may adjust the secondary control, such as duty cycle, rail voltage or phase, to bring the level of power into line with the demands of the remote device 12. In the embodiment of FIG. 1, the adaptive control system 14 has the ability to adjust operating frequency and duty cycle. In this embodiment, the control system 14 will maintain the operating frequency at a frequency that allows communication and will adjust the duty cycle up or down as needed to provide the desired power level.

In some applications, it may be desirable for the wireless power supply 10 to maintain a record of operating parameters that have an adverse affect on the system so that those parameters can be avoided in the future. The wireless power supply 10 of FIG. 1 may be configured to detect operating characteristics that present adverse affects, maintain a record of those operating characteristics in memory (e.g. a list or table of adverse operating ranges) and avoid those operating characteristics once detected. For example, the next time the remote device 12 provides feedback that would otherwise cause the adaptive control system 14 to adjust the primary control into an adverse operating range, the system 14 may simply jump over the adverse range. If the remote device 12 indicates that this jump has overshot the desired power level, the adaptive control system 14 can adjust the power back using the secondary control. If the desired power level has not been overshot, it is an indication that the remote device 12 does not need to operate within the adverse operating range and the adaptive control system 14 can continue to adjust the system using the primary control. As an alternative to skipping over the adverse operating range, the adaptive control system 14 may switch to adjustment of the secondary control once the primary control reaches the boundary of the adverse operating range. For example, if the adaptive control system 14 was adjusting operating frequency to increase power supplied to the remote device 12 and the operating frequency reached the boundary of a problematic frequency range, the adaptive control system 14 might increase duty cycle instead of the continuing to adjust the operating frequency.

If adjustment of the secondary control is not able to provide the desired power, the adaptive control system 14 may return to adjustment of the primary control and skip over the adverse operating range. More specifically, in some situations, it may not be possible to make sufficient adjustments with the secondary control to obtain the power level requested by the remote device 12 while the primary control remains at a specific setting. For example, if the remote device 12 calls for more power when the primary control is at the lower boundary of an adverse operating range and the duty cycle is at its highest setting, it will not be possible to obtain a higher power level through further adjustments to the secondary control. Instead, it may be necessary to adjust the primary control (e.g. operating frequency) to move it to the opposite side of the adverse operating range and attempt to adjust power with the secondary control from the other direction. So, in the above, example, it may be necessary to adjust the operating frequency so that it is at the upper boundary of the adverse operating range. This may result in the remote device 12 receiving more power than required. If so, the adaptive control system 14 can lower the duty cycle to reduce the power as desired by the remote device 12.

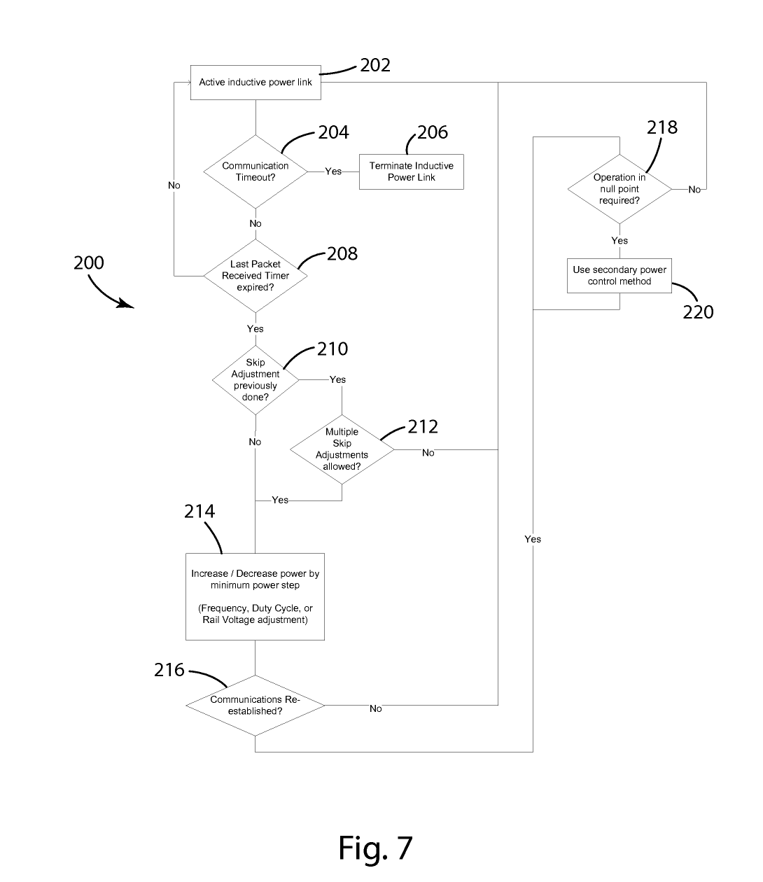

An embodiment of this control method will now be described with reference to FIG. 7. As shown, this control method 200 may include actively controlling the inductive power link 202 by receiving communications from the remote device 12 and making appropriate adjustments to the control parameter, for example, to adjust the power as requested by the remote device 12. Control may remain within this box unless and until a communication packet is not received within the expected time (e.g. every 250 milliseconds). If a communication packet is not received, control may flow to decision 204 where it is determined whether a sufficient amount of time has passed since the last packet was received to constitute a communication timeout. The amount of time required for a communication timeout may vary from application to application, but may, for example, be 1 second or 1.25 second. Upon communication timeout, the wireless power supply 10 may terminate the inductive link 206. The wireless power supply 10 may also maintain a Last Packet Received Timer. If the Last Packet Received Timer has expired 208 (e.g. a communication packet has not been received for a specified period of time) and there is not a communication timeout, the adaptive control system 14 may make further adjustments to the control parameter. The control system 14 may be configured to allow a specific number of adjustments. Decision block 210 effectively controls flow depending on whether or not this is the control system's first “skip adjustment” (e.g. adjustment made after communications were lost). If this is not the first skip adjustment, control moves to decision block 212 where the system 14 determines whether or not the number of allowed skip adjustments have been made. If no further skip adjustments are permitted, control returns to block 202. If the system 14 continues to not receive communications for a sufficient period of time, the system 14 will reach a communication timeout and the inductive power link will be terminated 206. If the number of permitted skip adjustments has not been exceeded, control passes to block 214 where the control parameter is adjusted. If the previous adjustment was to increase power, then the system 14 adjusts the operating parameter to further increase power. If the previous adjustment was to decrease power, then the system 14 adjusts the operating parameter to further decrease power. The step size of each increase/decrease may vary from application to application.

After the appropriate skip adjustment is made, control flows to decision block 216 where the system 14 determines whether communication have been re-established. If not, control returns to the active control box 202. If communication has been re-established, the wireless power supply 10 determines 218 whether operation within the keep-out range (or null point) is desired. For example, the adaptive control system 14 may determine that operation within a keep-out range is required if the remote device 12 immediately requests the wireless power supply 10 reverse the direction of its adjustments back into the adverse operating range. If so, the adaptive control system 14 switches 220 to the secondary control to provide the requested amount of power, and control may be returned to block 202. If the remote device feedback does not call for operation within the keep-out range, control can return to box 202 and the adaptive control system 14 can continue to control the system using the primary control.

In the preceding embodiment, the wireless power supply 10 detects the adverse operating ranges on its own during operation. Alternatively or in addition, the control system 14 may be provided with undesirable operating characteristics in advance. For example, the wireless power supply 10 may be preprogrammed to include a table or other memory structure that lists known adverse operating ranges. This may involve testing the wireless power supply 10 with one or more remote devices 12 to determine the adverse operating ranges, such as operating ranges where communications are lost or functionality of the remote device 12 or wireless power supply 10 is adversely affected. The known adverse operating range or ranges may be associated with operating frequencies of external devices or may be set to comply with regulatory emission standards. For example, the wireless power supply 10 may be configured to avoid operating frequency ranges that are associated with other devices that have the potential to interfere with the wireless power supply, such as RFID, NFC, wireless tire pressure sensors and other similar devices, or that may create issues with regulatory emission standards. Although the adverse operating range or ranges may be selected to protect or facilitate operation of the remote device 12 or the wireless power supply 10, they may alternatively or additionally be selected to protect or facilitate operation of external devices that might be adversely impacted by the electromagnetic fields generated by the wireless power supply 10. During operation, the adaptive control system 14 may compare actual operating parameters against the stored adverse operating ranges to ensure that the adaptive control system 14 does not move the system into an adverse operating range.

In some applications, the remote device 12 may advise the wireless power supply 10 of undesirable operating characteristics. In such applications, the remote device 12 may be preprogrammed to include a table or other memory structure that lists know adverse operating ranges. Alternatively, the remote device 12 may be capable of determining adverse operating ranges during operation. The remote device 12 may transfer those adverse operating ranges to the wireless power supply 10, for example, at the initiation of a power supply session or at any time during operation. The remote device 12 may provide specific information concerning the keep-out ranges or it may provide the wireless power supply 10 with a key that allows the control system to determine the keep-out ranges. For example, the remote device 12 may send an identification packet that is a key to a look-up table in the wireless power supply 10 from which the adaptive control system 14 can determine the applicable keep-out ranges. The identification may be tied to a device-type identification or it may be a separate identification.

As another alternative, the adaptive control system 14 may not be directly responsible for avoiding undesirable operating parameters. Instead, the adaptive control system 14 may receive control signals from the remote device 12 that cause the control system to avoid undesirable operating parameters. For example, the remote device 12 may be responsible for telling the adaptive control system 14 whether to adjust the primary control or the secondary control, and this decision may be made by the remote device 12 when the remote device 12 determines that the system is approaching a keep-out range. When the remote device 12 recognizes that the adaptive control system 14 is approaching a keep-out range for the primary control, it may specifically direct the adaptive control system 14 to adjust the secondary control instead of the primary control. In some application, it may be desirable to provide a system in which both wireless power supply 10 and the remote device 12 are configured to determine keep-out ranges, and are provided with the ability to avoid operating in a keep-out range.

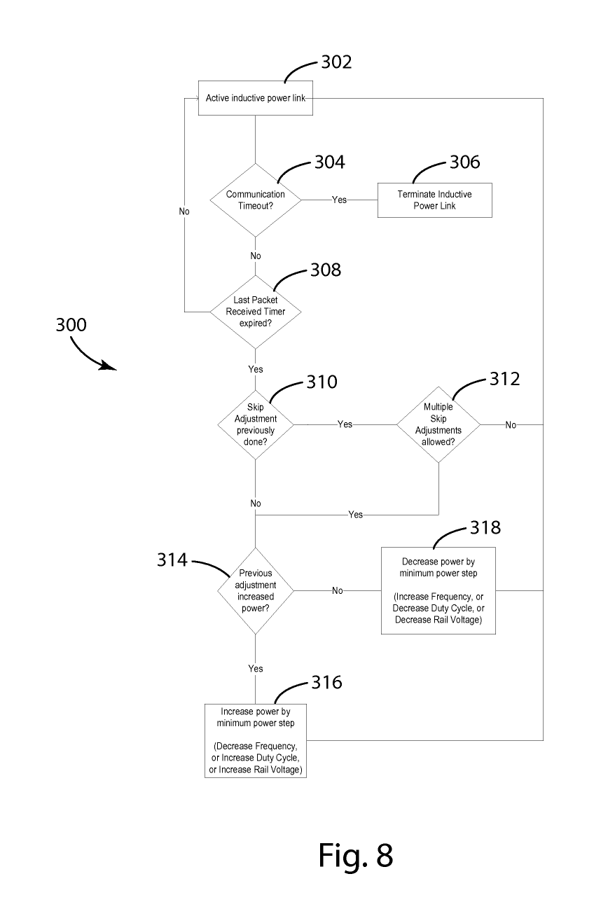

In an alternative embodiment, the wireless power supply 10 may be configured to operate with a single control parameter rather than the primary and secondary controls described above. In this embodiment, the adaptive control system 14 may be configured to move through adverse operating ranges by continuing to adjust the control parameter in the same direction that it was being adjusted before communications were lost. The wireless power supply 10 may limit the amount of time or number of adjustments that the adaptive control system 14 can apply before a timeout occurs and the system 14 takes remedial actions, such as terminating the inductive power link. One embodiment of this alternative control method will not be described with reference to FIG. 8. As shown, this control method 300 may include actively controlling the inductive power link 302 by receiving communications from the remote device 12 and making appropriate adjustments to the control parameter, for example, to adjust the power as requested by the remote device 12. Control may remain within this box unless and until a communication packet is not received at the expected time (e.g. every 250 milliseconds). If a communication packet is not received, control may flow to decision 304 where it is determined whether a sufficient amount of time has passed since the last packet was received to constitute a communication timeout. The amount of time required for a communication timeout may vary from application to application, but may, for example, be 1 second or 1.25 second. Upon communication timeout, the wireless power supply 10 may terminate the inductive link 306. The wireless power supply 10 may also maintain a Last Packet Received Timer. If the Last Packet Received Timer has expired 308 (e.g. a communication packet has not been received for a specified period of time) and there is not a communication timeout, the adaptive control system 14 may make further adjustments to the control parameter. The control system 14 may be configured to allow a specific number of adjustment. Decision block 310 effectively controls flow depending on whether or not this is the control system's first “skip adjustment” (e.g. adjustment made after communications were lost). If this is not the first skip adjustment, control moves to decision block 312 where the system 14 determines whether or not the number of allowed skip adjustments have been made. If no further skip adjustments are permitted, control returns to block 302. If the system 14 continues to not receive communications, the system 14 will reach a communication timeout and the inductive power link will be terminated. If the number of permitted skip adjustments has not been exceeded, control passes to decision block 314. If the previous adjustment was to increase power, then the system 14 adjusts the operating parameter 316 in the same direction to further increase power. If the previous adjustment was to decrease power, then the system 14 adjusts the operating parameter 318 in the same direction to further decrease power. The step size of each increase/decrease may vary from application to application. After the skip adjustment is made, control returns to the active control box 302.

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of any claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims.

The embodiments of the invention in which an exclusive property or privilege is claimed are defined as follows:

1. A wireless power supply for transferring power to a remote device, said wireless power supply comprising:
a wireless power transmitter for transferring power to the remote device according to at least one operating parameter, said wireless power transmitter configured to form an inductive power link between said wireless power supply and the remote device;
an adaptive control system coupled to said wireless power transmitter, said adaptive control system configured to adjust said at least one operating parameter to control power transfer from said wireless power transmitter to the remote device, wherein said adaptive control system is configured to avoid operating at adverse operating parameters that adversely affect communication between said wireless power supply and the remote device or that adversely affect operation of the remote device.

2. The wireless power supply of claim 1 further including a communication circuit coupled to said wireless power transmitter, said communication circuit configured to receive information from the remote device.

3. The wireless power supply of claim 2 wherein:
the remote device includes a receiver for forming said inductive power link with said wireless power transmitter;
said communication circuit receives information from the remote device via said inductive power link; and
said information relates to an amount of power to be transferred to the receiver in the remote device.

4. The wireless power supply of claim 2 wherein said information from the remote device relates to a keep-out range for operating parameters that adversely affect communication between said wireless power supply and the remote device or that adversely affect operation of the remote device.

5. The wireless power supply of claim 4 wherein said information includes at least one of (a) a key to a look-up table stored in memory from which said wireless power supply determines said keep-out range and (b) specific information of said keep-out range.

6. The wireless power supply of claim 1 wherein said adaptive control system is configured to detect adverse operating parameters that adversely affect the remote device, maintain a record of said adverse operating parameters that adversely affect the remote device, and control said at least one operating parameter to avoid said adverse operating parameters.

7. The wireless power supply of claim 1 wherein said adaptive control system includes a memory configured to store adverse operating parameters to be avoided, said memory programmed with said adverse operating parameters during manufacturing.

8. The wireless power supply of claim 7 wherein said adverse operating parameters programmed into said memory are selected to at least one of avoid interference from anticipated proximate systems, avoid interfering with the anticipated proximate systems, and comply with regulatory emission standards.

9. The wireless power supply of claim 8 wherein the anticipated proximate systems include at least one of an RFID device, an NFC compliant device, and a wireless tire pressure sensor.

10. The wireless power supply of claim 7 wherein said memory includes a look-up table of stored adverse operating parameters associated with a plurality of remote devices, wherein in response to determining that the remote device corresponds to one of said plurality of remote devices, said adaptive control system retrieves from memory said stored adverse operating parameters for the remote device.

11. The wireless power supply of claim 1 wherein said at least one operating parameter includes a primary control and a secondary control, wherein said adaptive control system is configured to adjust said primary control to control an amount of power transferred to the remote device, wherein said adaptive control system is configured to adjust said secondary control to control said amount of power transferred to the remote device in response to determining that said primary control is at or near a boundary of an adverse operating range.

12. The wireless power supply of claim 11 wherein said wireless power transmitter includes a drive circuit and a tank circuit, wherein said adaptive control system is configured to adjust said primary control and said secondary control depending on whether a topology of said drive circuit is a half-bridge topology or a full-bridge topology.

13. The wireless power supply of claim 1 wherein said adaptive control system is configured to adjust said at least one operating parameter to jump over an adverse operating range in order to avoid adversely affecting the remote device.

14. The wireless power supply of claim 13 wherein said adaptive control system is configured to adjust a secondary control to control an amount of power transferred to the remote device in response to determining that said jump has overshot a desired power level.

15. The wireless power supply of claim 1 wherein said at least one operating parameter includes at least one of operating frequency, duty cycle, rail voltage, and switching circuit phase, wherein said adaptive control system is configured to adjust two or more of said operating frequency, said duty cycle, said rail voltage, and said switching circuit phase.

16. The wireless power supply of claim 1 further including a detector circuit coupled to said wireless power transmitter, said detector circuit configured to provide an output signal as a function of a characteristic of power in said wireless power transmitter that is affected by data communicated by reflected impedance through said inductive power link.

17. The wireless power supply of claim 16 wherein said detector circuit is configured to filter and process said characteristic of power into a series of highs and lows representative of data carried over said inductive power link.

18. The wireless power supply of claim 1 further comprising a communication circuit for receiving information from the remote device, wherein said adaptive control system is configured to adjust said at least one operating parameter to control power based on said information received from the remote device.

19. The wireless power supply of claim 1 further including a communication circuit for at least one of receiving information from and transmitting information to the remote device.

20. A method of operating a wireless power supply to transfer power to a remote device, said method comprising:
placing a remote device in sufficient proximity to the wireless power supply to form an inductive power link between the wireless power supply and the remote device;
operating the wireless power supply according to at least one operating parameter to transfer power to the remote device via the inductive power link;
receiving, in the wireless power supply, a communication packet from the remote device;
based on the communication packet, controlling the at least one operating parameter to control an amount of power transferred to the remote device, wherein the at least one operating parameter is controlled to avoid adversely affecting communication with the remote device or operation of the remote device.

21. The method of claim 20 further comprising:
detecting operating parameters that adversely affect communication with the remote device; and
maintaining a record of the operating parameters that adversely affect communication.

22. The method of claim 20 wherein the at least one operating parameter includes a primary control and a secondary control, wherein based on the primary control being at or near a boundary of an adverse operating range, controlling the secondary control to control the amount of power transferred and to avoid adversely affecting communication with the remote device.

23. The method of claim 22 wherein the primary control is operating frequency control and the secondary control is at least one of rail voltage control, duty cycle control, and phase control, wherein an operating frequency in the adverse operating range causes interference.

24. The method of claim 22 wherein the primary control is duty cycle control and the secondary control is rail voltage control, wherein a duty cycle in the adverse operating range causes harmonic content.

25. The method of claim 22 wherein the primary control is rail voltage control and the secondary control is at least one of phase control and operating frequency control, wherein a rail voltage in the adverse operating range is beyond maximum or minimum allowed conditions.

26. The method of claim 22 wherein the primary control is phase control and the secondary control is at least one of operating frequency control and duty cycle control, wherein a phase angle in the adverse operating range causes interference or is beyond maximum or minimum allowed conditions.

27. The method of claim 20 further comprising periodically receiving from the remote device a communication packet as a keep alive signal, wherein in response to failing to receive a communication packet for a pre-determined period of time, controlling the at least one operating parameter to at least one of re-establish communication and terminate the inductive power link.

28. The method of claim 27 wherein re-establishing communication includes adjusting the at least one operating parameter in a same direction as its last adjustment to move out of an adverse parameter condition and allow communication to be re-established.

29. The method of claim 28 wherein the at least one operating parameter is operating frequency; and wherein the operating frequency is step-wise increased to move through the adverse parameter condition.

30. The method of claim 27 wherein the at least one operating parameter includes a primary control and a secondary control, and wherein in response to re-establishing communication and receiving a request to change the amount of power transferred to the remote device, adjusting the secondary control to change the amount of power transferred and to avoid adversely affecting communication with the remote device.

31. The method of claim 20 wherein the communication packet includes a request to increase power or decrease power.

32. The method of claim 20 wherein the communication packet includes information relating to a keep-out range for operating parameters that adversely affect communication with the remote device or operation of the remote device, wherein the information includes at least one of (a) a key to a look-up table stored in memory from which the keep-out range is determined and (b) specific information of the keep-out range.

33. The method of claim 20 further comprising retrieving from memory adverse operating parameters, wherein said controlling step includes controlling the at least one operating parameter to avoid the adverse operating parameters.

34. The method of claim 33 wherein the adverse operating parameters in memory are programmed during manufacturing, and wherein the adverse operating parameters are selected to at least one of avoid interference from anticipated proximate systems, avoid interfering with anticipated proximate systems, and comply with regulatory emission standards.

35. A wireless power supply system comprising:
an inductive power supply including:
a wireless power transmitter for transferring power according to at least one operating parameter, said wireless power transmitter configured to generate an electromagnetic field for power transfer; and
an adaptive control system coupled to said wireless power transmitter, said adaptive control system configured to adjust said at least one operating parameter to control power transfer via said electromagnetic field;
a remote device separable from said inductive power supply, said remote device for receiving inductive power via said electromagnetic field, said remote device including:
a secondary for generating electrical power in response to said electromagnetic field generated by said inductive power supply;
communication circuitry for communicating with said inductive power supply; and
a load coupled to said secondary, said load for receiving electrical power generated in said secondary in response to said electromagnetic field;
wherein said adaptive control system is configured to adjust said at least one operating parameter to avoid adversely affecting communication with said inductive power supply or adversely affecting operation of said remote device.

36. The wireless power supply system of claim 35 wherein said remote device includes a receiver having said secondary and said communication circuitry, said receiver transmitting to said inductive power supply information relating to an amount of power to be transmitted to said receiver.

37. The wireless power supply system of claim 35 wherein said communication circuitry is coupled to said secondary, and wherein said communication circuitry is configured to transmit to said inductive power supply information relating to an amount of power to be transferred to said remote device.

38. The wireless power supply system of claim 35 wherein said adaptive control system is configured to adjust said at least one operating parameter to control power based on information received from said remote device via said electromagnetic field.

39. The wireless power supply system of claim 35 wherein said adaptive control system is configured to:
detect adverse operating parameters that adversely affect said remote device;
maintain a record of said adverse operating parameters that adversely affect communication with said remote device or operation of said remote device; and
control said at least one operating parameter to avoid said adverse operating parameters.

40. The wireless power supply system of claim 35 wherein said at least one operating parameter includes a primary control and a secondary control, wherein said adaptive control system is configured to adjust said primary control to control an amount of power transferred to said remote device, wherein said adaptive control system is configured to adjust said secondary control to control said amount of power transferred to said remote device in response to determining that said primary control is at or near a boundary of an adverse operating range.

41. The wireless power supply system of claim 35 wherein said remote device communicates to said inductive power supply information relating to a keep-out range for operating parameters that adversely affect communication with said remote device or operation of said remote device.

42. The wireless power supply system of claim 41 wherein said information includes a key to a look-up table from which said inductive power supply determines said keep-out range.

43. The wireless power supply system of claim 35 wherein said adaptive control system includes a memory configured to store adverse operating parameters to be avoided.

44. The wireless power supply system of claim 43 wherein said adverse operating parameters are programmed during manufacturing, and wherein said adverse operating parameters are selected to at least one of avoid interference from anticipated proximate systems, avoid interfering with the anticipated proximate systems, and comply with regulatory emission standards.

45. The wireless power supply system of claim 44 wherein the anticipated proximate systems include at least one of an RFID device, an NFC compliant device, and a wireless tire pressure sensor.
